(19) United States
(12) Patent Application Publication
(10) Pub. No.: US 2022/0294147 A1
(43) Pub. Date: Sep. 15, 2022

(54) CONNECTOR ASSEMBLY

(71) Applicant: HIROSE KOREA CO., LTD., Siheung-si (KR)

(72) Inventor: Chang Ho LEE, Siheung-si (KR)

(73) Assignee: HIROSE KOREA CO., LTD., Siheung-si (KR)

(21) Appl. No.: 17/691,556

(22) Filed: Mar. 10, 2022

(30) Foreign Application Priority Data
Mar. 12, 2021 (KR) 10-2021-0032481

(51) Int. Cl. H01R 13/405; H01R 13/627; H01R 12/71

(52) U.S. Cl. CPC H01R 13/405; H01R 13/6273; H01R 12/716

(57) ABSTRACT

A connector assembly includes: a plug connector including a mold support, a first terminal structure protruding from the mold support in a first direction, and a first housing surrounding the mold support and the first terminal structure; and a receptacle connector including a second terminal structure electrically connected to the first terminal structure and a second housing surrounding the second terminal structure and fastened to the first housing, wherein the first housing includes a cylindrical first plug periphery surrounding the mold support and extending in the first direction, and a second plug periphery protruding from the first plug periphery in the first direction. The second plug periphery includes a protruding wall covering at least part of both sides of the first terminal structure and a cover covering an upper surface of the first terminal structure, and exposes a lower surface of the first terminal structure.

### CROSS-REFERENCE TO RELATED APPLICATION

This patent document claims priority to and the benefit of Korean Patent Application No. 10-2021-0000000, filed on Mar. 12, 2021, the entire disclosure of which is incorporated by reference for all purposes as if fully set forth herein.

### TECHNICAL FIELD

The present invention relates to a connector assembly. More particularly, the present invention relates to a connector assembly for a universal serial bus (USB).

### BACKGROUND

In general, a connector assembly may include a plug connector and a receptacle connector. The receptacle connector may be mounted on a printed circuit board (PCB) of an electronic device to be fastened to the plug connector.

Each of the plug connector and the receptacle connector may include multiple connection terminals, a mold structure supporting the multiple connection terminals, and a housing surrounding the mold structure. The connection terminals are insulated from each other by the mold structure and shielded by the housing surrounding the mold structure. The connection terminals may be arranged so as to satisfy, for example, a pin standard of the universal serial bus (USB).

Japanese Patent Unexamined Publication No. 2020-077524 (2020 May 21) and No. 2020-095916 (2020Jun. 18) disclose conventional connector assemblies.

### SUMMARY

It is an aspect of the present invention to provide a connector assembly that can be miniaturized and has high strength.

It will be understood that the present invention is not limited to the above aspect and other aspects of the present invention will become apparent to those skilled in the art from the detailed description of embodiments in conjunction with the accompanying drawings.

In accordance with some embodiments of the present invention, a connector assembly includes: a plug connector including a mold support, a first terminal structure protruding from the mold support in a first direction, and a first housing surrounding the mold support and the first terminal structure; and a receptacle connector including a second terminal structure electrically connected to the first terminal structure and a second housing surrounding the second terminal structure and fastened to the first housing, wherein the first housing includes a cylindrical first plug periphery surrounding the mold support and extending in the first direction, and a second plug periphery protruding from the first plug periphery in the first direction and exposing a lower surface of the first terminal structure, the second plug periphery including a protruding wall covering at least part of both sides of the first terminal structure and a cover covering an upper surface of the first terminal structure.

In some embodiments, the second plug periphery protrudes beyond the first terminal structure in the first direction.

In some embodiments, the first housing further includes a recess disposed beneath the protruding wall and exposing a portion of a front surface of the first plug periphery.

In some embodiments, the second housing includes a first receptacle periphery surrounding the second terminal structure, a protruding base protruding from a lower portion of the first receptacle periphery and corresponding to the recess, and a second receptacle periphery surrounding the first receptacle periphery, and the second plug periphery is inserted into a space between the first receptacle periphery and the second receptacle periphery.

In some embodiments, the second receptacle periphery has a greater width than the protruding base in a second direction intersecting the protruding wall.

In some embodiments, the protruding wall includes a guide groove indented from an outer surface thereof and extending in the first direction and the second receptacle periphery includes a guide pin protruding from an inner surface thereof and corresponding to the guide groove.

In some embodiments, the first housing further includes a plug locking portion disposed between the cover and the first terminal structure and extending in the first direction, and the second housing further includes a receptacle locking portion protruding from an upper surface of the first receptacle periphery and fastened to the plug locking portion.

In some embodiments, the plug locking portion includes a first locking arm and a second locking arm separated from each other and extending parallel to each other in the first direction, and a locking arm bridge extending in a second direction intersecting the first direction and connecting the first locking arm to the second locking arm, and the receptacle locking portion is inserted into a space between the first locking arm and the second locking arm to be fastened to the locking arm bridge.

In some embodiments, the first housing further includes a locking guide disposed between the plug locking portion and the first terminal structure and protruding from an inner surface of the protruding wall, the locking guide including a guide groove extending in the first direction, and the receptacle locking portion is inserted into the guide groove.

In some embodiments, the first terminal structure includes a first mold structure held by the mold support, multiple plug terminals supported by the first mold structure, and a first cylindrical shell surrounding the multiple plug terminals and extending in the first direction, and the second plug periphery protrudes beyond the first shell in the first direction.

In some embodiments, the second terminal structure includes a second mold structure mounted on the circuit board, multiple receptacle terminals supported by the second mold structure, and a second cylindrical shell surrounding the multiple receptacle terminals and extending in the first direction.

Details of other embodiments will be described in the following description with reference to the accompanying drawings.

Embodiments of the present invention provide the following effects.

In the connector assembly according to some embodiments, a first housing 100 of a plug connector 10 has a second plug periphery 120 that surrounds some portions of a first terminal structure 220. With this structure, the first housing 100 can improve strength of the connector assembly by firmly protecting the first terminal structure 220 from an external environment.

Further, the first housing 100 of the plug connector 10 has a recess 100R that exposes other portions of the first terminal structure 220. The recess 100R of the first housing 100 provides a space for a second housing 400 fastened to the first housing 100, thereby enabling miniaturization of the connector assembly.

The present invention is not limited thereto and other effects of the present invention will become apparent from the following description.

### BRIEF DESCRIPTION OF THE DRAWINGS

The above and other aspects, features, and advantages of the present invention will become apparent from the detailed description of the following embodiments in conjunction with the accompanying drawings:

FIG. 1 is a perspective view of a connector assembly according to some embodiments of the present invention;

FIG. 2 and FIG. 3 are exploded perspective views of a plug connector shown in FIG. 1;

FIG. 4 is a perspective view of the plug connector shown in FIG. 1;

FIG. 5 is a cross-sectional view taken along line A-A of FIG. 4;

FIG. 6 is a cross-sectional view taken along line B-B of FIG. 4;

FIG. 7 is an exploded perspective view of a receptacle connector shown in FIG. 1;

FIG. 8 is a perspective view of the receptacle connector shown in FIG. 1;

FIG. 9 is a cross-sectional view taken along line C-C of FIG. 8;

FIG. 10 is a perspective view of the connector assembly according to the embodiments of the present invention in a fastened state;

FIG. 11 is a cross-sectional view taken along line D-D of FIG. 10;

FIG. 12 is an enlarged view of Region R of FIG. 11; and

FIG. 13 is a perspective view of a connector assembly according to other embodiments of the present invention.

### DETAILED DESCRIPTION OF EMBODIMENTS

Hereinafter, exemplary embodiments of the present invention will be described in detail with reference to the accompanying drawings. It should be understood that the present invention is not limited to the following embodiments and may be embodied in different ways, and that the embodiments are provided for complete disclosure and thorough understanding of the present invention by those skilled in the art. The scope of the present invention is defined only by the claims. Like components will be denoted by like reference numerals throughout the specification.

When an element is referred to as being “on,” “connected to,” or “coupled to” another element, it may be directly on, connected to, or coupled to the other element or intervening elements or layers may be present. However, when an element is referred to as being “directly on,” “directly connected to,” or “directly coupled to” another element, there are no intervening elements or layers present. Herein, “and/or” includes each of mentioned items and all combinations of at least one of the mentioned items.

When an element is referred to as being disposed “on” another element, it may be directly formed on the other element or intervening element(s) may also be “interposed” therebetween. When, however, an element is referred to as being “directly on” another element or layer, there are no intervening elements therebetween.

Spatially relative terms, such as “beneath,” “below,” “under,” “lower,” “above,” “upper,” “over,” “higher,” “side” (for example, as in “sidewall”), and the like, may be used herein for descriptive purposes, and, thereby, to describe one element's relationship to other element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, components may be otherwise oriented and as such, the spatially relative terms used herein may be likewise interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Although the terms “first,” “second,” and the like may be used herein to describe various types of elements, these elements should not be limited by these terms. These terms are used to distinguish one element from another element. Thus, a first element discussed below could be termed a second element without departing from the teachings of the present invention.

Unless otherwise defined, all terms (including technical and scientific terms) used herein have the same meaning as commonly understood by one of ordinary skill in the art to which the present invention pertains. Terms, such as those defined in commonly used dictionaries, should be interpreted as having a meaning that is consistent with their meaning in the context of the relevant art and should not be interpreted in an idealized or overly formal sense, unless expressly so defined herein.

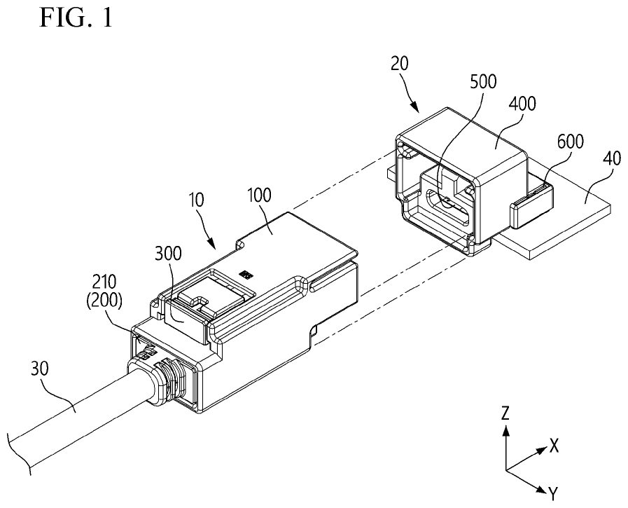

Hereinafter, a connector assembly according to exemplary embodiments of the present invention will be described with reference to FIG. 1 to FIG. 12.

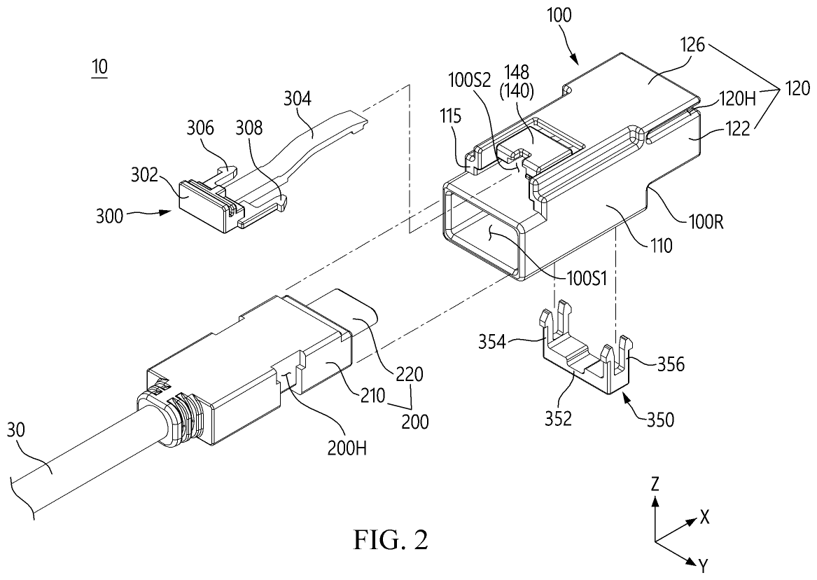

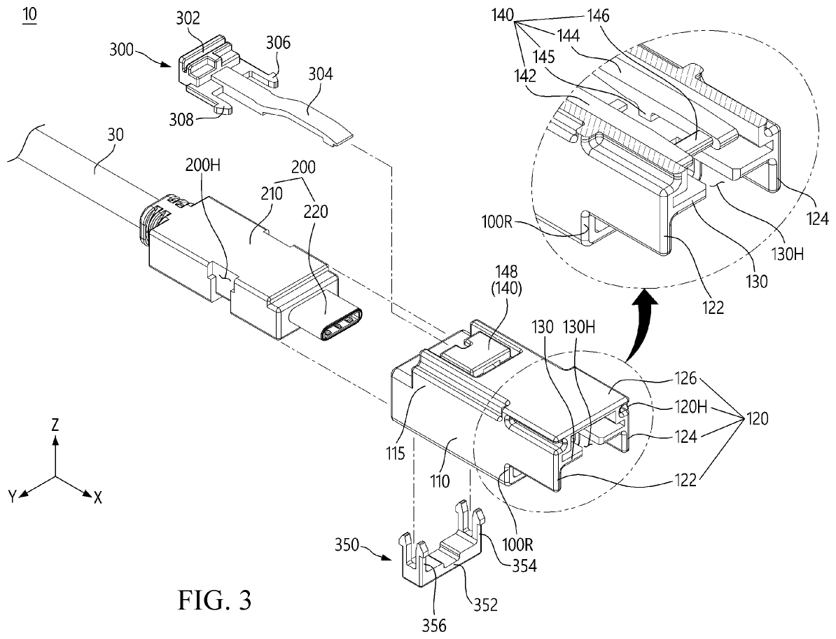

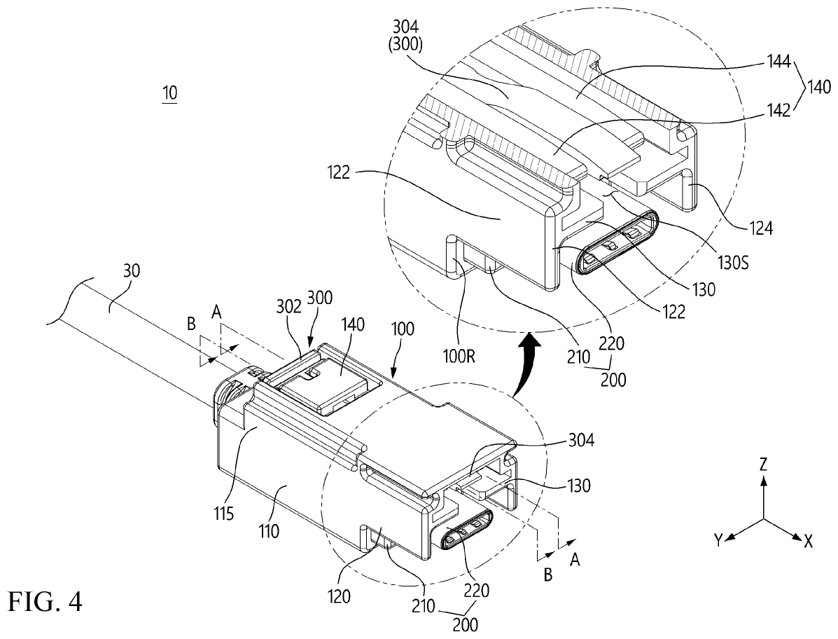

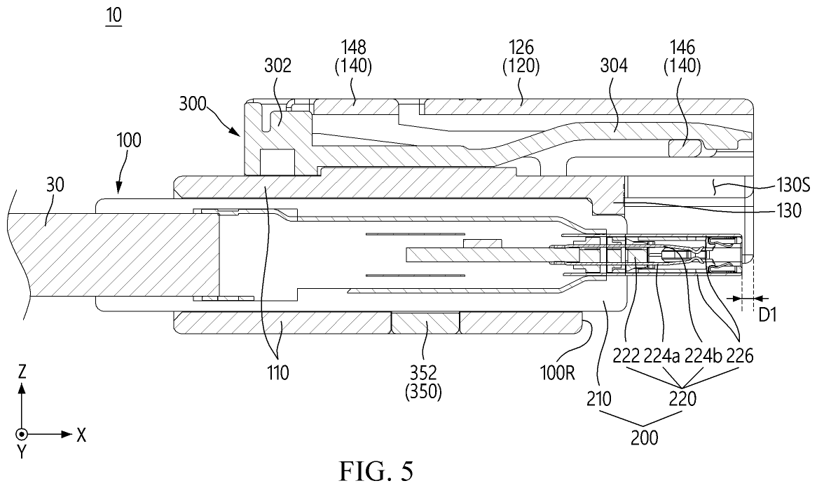

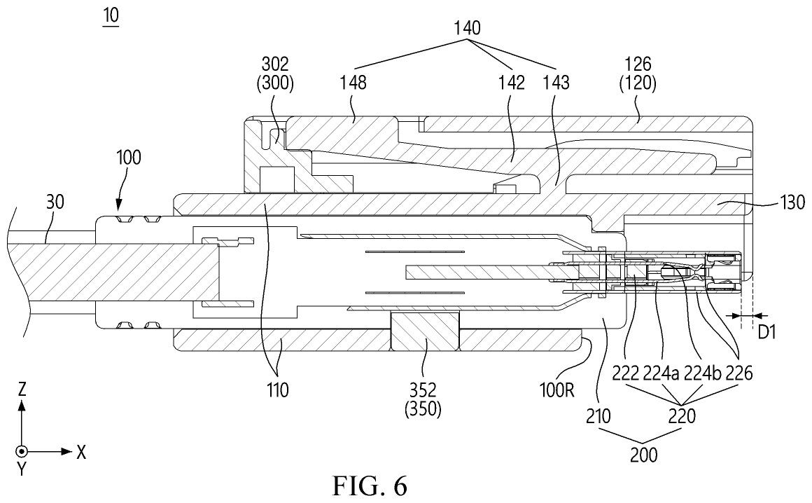

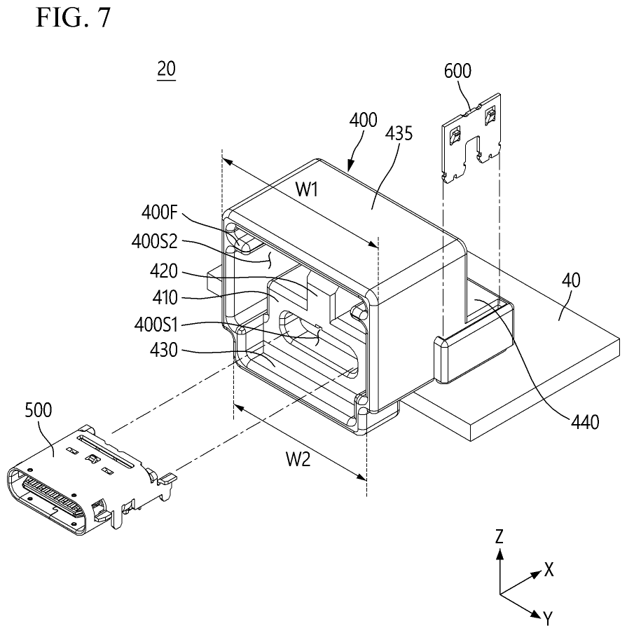

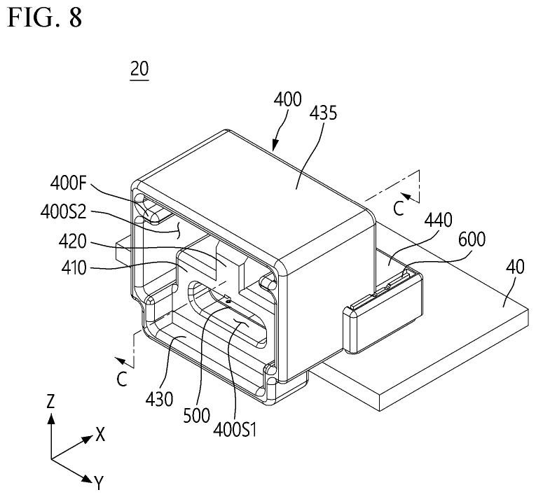

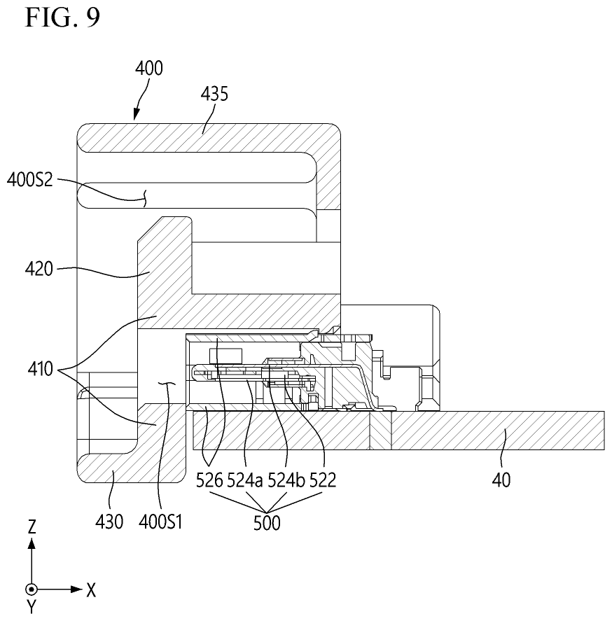

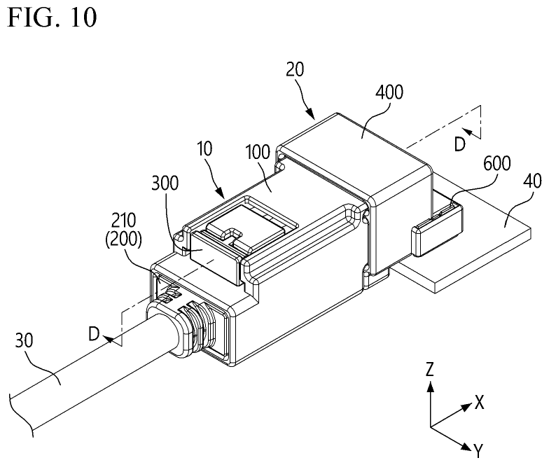

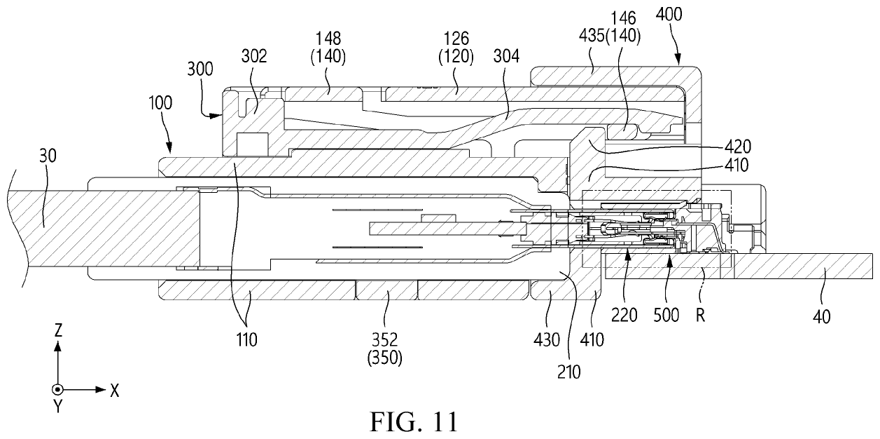

FIG. 1 is a perspective view of a connector assembly according to some embodiments of the present invention. FIG. 2 and FIG. 3 are exploded perspective views of a plug connector shown in FIG. 1. FIG. 4 is a perspective view of the plug connector shown in FIG. 1. FIG. 5 is a cross-sectional view taken along line A-A of FIG. 4. FIG. 6 is a cross-sectional view taken along line B-B of FIG. 4. FIG. 7 is an exploded perspective view of a receptacle connector shown in FIG. 1. FIG. 8 is a perspective view of the receptacle connector shown in FIG. 1. FIG. 9 is a cross-sectional view taken along line C-C of FIG. 8. FIG. 10 is a perspective view of the connector assembly according to the embodiments of the present invention in a fastened state. FIG. 11 is a cross-sectional view taken along line D-D of FIG. 10. FIG. 12 is an enlarged view of Region R of FIG. 11.

Referring to FIG. 1, the connector assembly according to the embodiments of the present invention includes a plug connector 10 and a receptacle connector 20.

The plug connector 10 may be fastened to the receptacle connector 20. For example, the plug connector 10 and the receptacle connector 20 may be arranged such that a front surface of the plug connector 10 faces a front surface of the receptacle connector 20, as shown in FIG. 1. Next, the plug connector 10 may be moved in a first direction X to be fastened to the receptacle connector 20. As a result, an electronic device (for example, a cable 30) connected to the plug connector 10 may be electrically connected to another electronic device (for example, a circuit board 40) connected to the receptacle connector 20.

Herein, the front surface (or front end) of the plug connector 10 refers to one surface (or one end) of the plug connector 10 facing the receptacle connector 20, and the front surface (or front end) of the receptacle connector 20 refers to one surface (or one end) of the receptacle connector 20 facing the plug connector 10.

Referring to FIGS. 1 to 6 and FIGS. 10 to 12, in the connector assembly according to the embodiments, the plug connector 10 may include a first housing 100, a plug terminal assembly 200, a connector positioning unit 300, and a first fastening holder 350.

The plug terminal assembly 200 may include a mold support 210 and a first terminal structure 220. The mold support 210 may support a cable 30 and the first terminal structure 220. For example, the cable 30 may extend in a first direction X and may be secured at one end thereof to the mold support 210. The first terminal structure 220 may be held by the mold support 210 and may protrude from the mold support 210 in the first direction X. The cable 30 and the first terminal structure 220 may be electrically connected to each other inside the mold support 210.

The first terminal structure 220 may include a first mold structure 222, multiple plug terminals 224a, 224b, and a first shell 226. The plug terminals 224a, 224b may be insulated from each other by the first mold structure 222. For example, the first mold structure 222 may be held by the mold support 210 and the plug terminals 224a, 224b separated from each other may be supported by the first mold structure 222. In some embodiments, the plug terminals 224a, 224b may protrude from the first mold structure 222 in the first direction X.

The plug terminals 224a, 224b may be protected by the first shell 226. For example, the first shell 226 may have a cylindrical shape surrounding the plug terminals 224a, 224b and extending in the first direction X. In some embodiments, the first shell 226 may be held by the mold support 210 and may protrude from the mold support 210 in the first direction X.

In some embodiments, the plug terminals 224a, 224b may be arranged so as to satisfy a pin standard of USB (universal serial bus). By way of example, the plug terminals 224a, 224b may be arranged so as to satisfy various pin standards, such as USB type-C, USB Micro B, USB 3.0, and the like.

The first housing 100 may surround the plug terminal assembly 200 to protect the plug terminal assembly 200. In addition, the first housing 100 may be fastened to the second housing 400 described below. The first housing 100 may include a first plug periphery 110, a protruding pin 115, a second plug periphery 120, a locking guide 130, and a plug locking portion 140.

The first plug periphery 110 may surround the mold support 210. For example, the first plug periphery 110 may have a cylindrical shape surrounding the mold support 210 and extending in the first direction X. The first plug periphery 110 may include a first plug reception space 100S1 extending in the first direction X. The mold support 210 may be inserted into the first plug reception space 100S1.

In some embodiments, the mold support 210 may protrude beyond the first plug periphery 110 in the first direction X. With this structure, the plug connector 10 may include a step formed by the mold support 210 and the first plug periphery 110, as shown in FIG. 5 and FIG. 6.

The protruding pin 115 may protrude from an upper surface of the first plug periphery 110 and may extend in the first direction X. The protruding pin 115 may define a second plug reception space 100S2 on the first plug periphery 110. For example, two protruding pins 115 may be formed adjacent to opposite sidewalls of the first plug periphery 110, respectively. The second plug reception space 100S2 may be defined between the protruding pins 115.

The second plug periphery 120 may protrude from the first plug periphery 110 and/or the protruding pins 115 in the first direction X. The second plug periphery 120 may surround a portion of the first terminal structure 220. In some embodiments, the second plug periphery 120 may cover at least part of both side surfaces of the first terminal structure 220 and an upper surface of the first terminal structure 220. For example, the second plug periphery 120 may include a first protruding wall 122, a second protruding wall 124, and a first cover 126.

The first protruding wall 122 and the second protruding wall 124 may extend from the opposite sidewalls of the first plug periphery 110 and/or the protruding pins 115 in the first direction X. Each of the first protruding wall 122 and the second protruding wall 124 may extend along a plane intersecting a second direction Y. The first protruding wall 122 and the second protruding wall 124 may cover at least part of both side surfaces of the first terminal structure 220. With this structure, the second plug periphery 120 may cover both side surfaces of the first terminal structure 220 from an external environment.

In some embodiments, the first protruding wall 122 and the second protruding wall 124 may protrude beyond the first terminal structure 220 in the first direction X. For example, as shown in FIG. 5 and FIG. 6, the first protruding wall 122 and the second protruding wall 124 may protrude a distance D1 from a front surface of the first terminal structure 220 (for example, the first shell 226). With this structure, the second plug periphery 120 may protect the first terminal structure 220 from an external environment.

Although a lower surface of the first terminal structure 220 is illustrated as being placed beneath lower surfaces of the first protruding wall 122 and the second protruding wall 124, it should be understood that this structure is provided by way of example. Alternatively, the lower surface of the first terminal structure 220 may be coplanar with or placed above the lower surfaces of the first protruding wall 122 and the second protruding wall 124.

The first cover 126 may connect an upper portion of the first protruding wall 122 to an upper portion of the second protruding wall 124. The first cover 126 may extend along a plane intersecting a third direction Z. The first cover 126 may cover the upper surface of the first terminal structure 220. With this structure, the second plug periphery 120 may protect the upper surface of the first terminal structure 220 from an external environment. In some embodiments, the first cover 126 may extend from the protruding pins 115 in the first direction X.

The second plug periphery 120 may partially expose the front surface of the first plug periphery 110. For example, the first housing 100 may include a recess 100R through which a portion of the front surface of the first plug periphery 110 is exposed. Through the recess 100R, the lower surface of the first terminal structure 220 may be exposed from the second plug periphery 120. In some embodiments, the recess 100R may be disposed beneath the first protruding wall 122 and the second protruding wall 124. For example, the recess 100R may expose a front surface of a lower portion of the first plug periphery 110.

In some embodiments, the second plug periphery 120 may include first guide grooves 120H. The first guide grooves 120H may be indented from outer surfaces of the first protruding wall 122 and the second protruding wall 124 and may extend in the first direction X. When the plug connector 10 is fastened to the receptacle connector 20, the first guide grooves 120H may guide the second housing 400 described below. Although the first guide grooves 120H are illustrated as being disposed adjacent to the first cover 126, it should be understood that this structure is provided by way of example and the number and locations of first guide grooves 120H may be changed as needed.

The locking guide 130 may be interposed between the first cover 126 and the first terminal structure 220. The locking guide 130 may protrude from inner surfaces of the first protruding wall 122 and the second protruding wall 124 and may extend along the plane intersecting the third direction Z. In some embodiments, the locking guide 130 may extend from the upper portion of the first plug periphery 110 in the first direction X.

The locking guide 130 may include a second guide groove 130S. The second guide groove 130S may be indented from a front surface of the locking guide 130 and may extend in the first direction X. When the plug connector 10 is fastened to the receptacle connector 20, the second guide groove 130S may guide the second housing 400 described below. Although the second guide groove 130S is illustrated as being disposed in a central region of the locking guide 130, it should be understood that this structure is provided by way of example and the number and locations of second guide grooves 130S may be changed as needed.

The plug locking portion 140 may be interposed between the first cover 126 and the locking guide 130. When the plug connector 10 is fastened to the receptacle connector 20, the plug locking portion 140 may be fastened to the second housing 400 described below. For example, the plug locking portion 140 may include a first locking arm 142, a second locking arm 144, a first arm support 143, a second arm support 145, a locking arm bridge 146, and a second cover 148. For convenience of description, the first cover 126 is omitted in FIG. 3 and FIG. 4.

The first locking arm 142 and the second locking arm 144 may extend parallel to each other in the first direction X to be separated each other. The first arm support 143 and the second arm support 145 may support the first locking arm 142 and the second locking arm 144 on the locking guide 130, respectively. For example, the first arm support 143 may protrude from a portion of an upper surface of the locking guide 130 adjacent to the first protruding wall 122 and the second arm support 145 may protrude from a portion of the upper surface of the locking guide 130 adjacent to the second protruding wall 124. The first arm support 143 may connect the locking guide 130 to the first locking arm 142 and the second arm support 145 may connect the locking guide 130 to the second locking arm 144.

The locking arm bridge 146 may extend in the second direction Y to connect the first locking arm 142 to the second locking arm 144. In some embodiments, the locking arm bridge 146 may connect a front end of the first locking arm 142 to a front end of the second locking arm 144. The locking arm bridge 146 may provide a space to be fastened by the second housing 400 between the first locking arm 142 and the second locking arm 144.

The second cover 148 may connect a rear end of the first locking arm 142 to a rear end of the second locking arm 144. The second cover 148 may be used to release connection between the plug connector 10 and the receptacle connector 20. For example, when pressure is applied to an upper surface of the second cover 148, the first locking arm 142 and the second locking arm 144 may be resiliently moved while being supported by the first arm support 143 and the second arm support 145. As a result, the locking arm bridge 146 may be moved in a direction away from the locking guide 130 and connection between the first housing 100 and the second housing 400 may be released.

In some embodiments, the second cover 148 may be interposed between the two protruding pins 115. In some embodiments, the second cover 148 and the first cover 126 may be disposed such that an upper surface of the second cover 148 may be coplanar with an upper surface of the first cover 126.

The connector positioning unit 300 serves to hold the second housing 400 fastened to the first housing 100. For example, the connector positioning unit 300 may be inserted into the second plug reception space 100S2 of the first housing 100 to support the plug locking portion 140 fastened to the second housing 400. In some embodiments, the connector positioning unit 300 may include a first base 302, a first fastening protrusion 304, a second fastening protrusion 306, and a third fastening protrusion 308.

The first base 302 may extend along a plane intersecting the first direction X. When the connector positioning unit 300 is inserted into the first housing 100, the first base 302 may be placed beneath the second cover 148. When the connector positioning unit 300 is inserted into the first housing 100, the first base 302 may be brought into contact with a rear surface of the second cover 148 to define an insertion limit of the connector positioning unit 300 into the first housing 100.

The first fastening protrusion 304 may extend from the first base 302 in the first direction X. When the connector positioning unit 300 is inserted into the first housing 100, the first fastening protrusion 304 may be disposed between the first locking arm 142 and the second locking arm 144. The first fastening protrusion 304 is fastened to the locking arm bridge 146 to hold the second housing 400 fastened to the first housing 100. In some embodiments, the front end of the first fastening protrusion 304 may be fastened to the front end of the locking arm bridge 146.

Each of the second fastening protrusion 306 and the third fastening protrusion 308 may extend from the first base 302 in the first direction X. For example, the second fastening protrusion 306 and the third fastening protrusion 308 may be disposed at opposite sides of the first fastening protrusion 304, respectively. When the connector positioning unit 300 is inserted into the first housing 100, the second fastening protrusion 306 and the third fastening protrusion 308 may be fastened to the protruding pin 115. As a result, the connector positioning unit 300 may be secured to the first housing 100.

The first fastening holder 350 may be used to hold the plug terminal assembly 200 inserted into the first housing 100. For example, the first fastening holder 350 may be inserted into the mold support 210 through the first plug periphery 110 in the third direction Z, in which the mold support 210 is inserted into the first plug periphery 110. In some embodiments, the first fastening holder 350 may include a second base 352, a fourth fastening protrusion 354, and a fifth fastening protrusion 356.

The second base 352 may extend along a plane intersecting the third direction Z. Each of the fourth fastening protrusion 354 and the fifth fastening protrusion 356 may extend from the second base 352 in the third direction Z. For example, the fourth fastening protrusion 354 and the fifth fastening protrusion 356 may be disposed at opposite ends of the second base 352, respectively. When the mold support 210 is inserted into the first plug periphery 110, the fourth fastening protrusion 354 and the fifth fastening protrusion 356 may be fastened to opposite sidewalls of the mold support 210 through a lower portion of the first plug periphery 110. With this structure, the first fastening holder 350 may hold the plug terminal assembly 200 inserted into the first housing 100.

Referring to FIG. 1 and FIG. 7 to FIG. 12, in some embodiments, the receptacle connector 20 may include the second housing 400, a second terminal structure 500, and second fastening holders 600.

The second terminal structure 500 may include a second mold structure 522, multiple receptacle terminals 524a, 524b, and a second shell 526. The receptacle terminals 524a, 524b may be insulated from each other by the second mold structure 522. For example, the second mold structure 522 may be mounted on the circuit board 40 and the receptacle terminals 524a, 524b may be supported by the second mold structure 522 to be separated from each other. In some embodiments, the receptacle terminals 524a, 524b may be exposed through some portions of upper and lower surfaces of the second mold structure 522.

The receptacle terminals 524a, 524b may be protected by the second shell 526. For example, the second shell 526 may have a cylindrical shape surrounding receptacle terminals 524a, 524b and extending in the first direction X. In some embodiments, the second shell 526 may be mounted on the circuit board 40.

The receptacle terminals 524a, 524b may be arranged corresponding to the plug terminals 224a, 224b. By way of example, the receptacle terminals 524a, 524b may be arranged so as to satisfy various pin standards, such as USB type-C, USB Micro B, USB 3.0, and the like.

As the plug connector 10 is fastened to the receptacle connector 20, the first terminal structure 220 may be electrically connected to the second terminal structure 500. For example, as shown in FIG. 12, the plug terminals 224a, 224b may be connected to the receptacle terminals 524a, 524b. With this structure, the plug connector 10 and the receptacle connector 20 may electrically connect a cable 30 to the circuit board 40.

The second housing 400 may surround the second terminal structure 500 to protect the second terminal structure 500. In addition, the second housing 400 may be fastened to the first housing 100. The second housing 400 may include a first receptacle periphery 410, a receptacle locking portion 420, a protruding base 430, a second receptacle periphery 435, and a receptacle mount 440.

The first receptacle periphery 410 may surround the second terminal structure 500. For example, the first receptacle periphery 410 may include a first receptacle reception space 400S1 extending in the first direction X. The second terminal structure 500 may be disposed in the first receptacle reception space 400S1.

In some embodiments, a front end of the first receptacle periphery 410 may protrude beyond a front surface of the second terminal structure 500 (for example, the second shell 526). With this structure, when the plug connector 10 is fastened to the receptacle connector 20, the first receptacle reception space 400S1 of the first receptacle periphery 410 may guide the first terminal structure 220.

The protruding base 430 may extend from the first receptacle periphery 410 corresponding to the recess 100R of the first housing 100. For example, the protruding base 430 may protrude from a front side of a lower portion of the first receptacle periphery 410. Accordingly, the receptacle connector 20 may include a step formed by the first receptacle periphery 410 and the protruding base 430, as shown in FIG. 9.

When the plug connector 10 is fastened to the receptacle connector 20, the step formed by the first receptacle periphery 410 and the protruding base 430 may correspond to the step formed by the mold support 210 and the first plug periphery 110. For example, as shown in FIG. 11, the front surface of the first receptacle periphery 410 may face the front surface of the mold support 210 and the front surface of the protruding base 430 may face the front surface of the first plug periphery 110.

The second receptacle periphery 435 may extend from the protruding base 430. The second receptacle periphery 435 may surround the first receptacle periphery 410. When the plug connector 10 is fastened to the receptacle connector 20, the second receptacle periphery 435 may receive the first housing 100. For example, a second receptacle reception space 400S2 may be defined between the first receptacle periphery 410 and the second receptacle periphery 435. The second plug periphery 120 of the first housing 100 may be inserted into the second receptacle reception space 400S2.

In some embodiments, the second receptacle periphery 435 may include guide pins 400F. The guide pins 400F may protrude from an inner surface of the second receptacle periphery 435 and may extend in the first direction X. The guide pins 400F may correspond to the first guide grooves 120H of the first housing 100. With this structure, when the plug connector 10 is fastened to the receptacle connector 20, the second housing 400 may be guided to the first housing 100.

In some embodiments, a width W1 of the second receptacle periphery 435 in the second direction Y may be greater than a width W2 of the protruding base 430 in the second direction Y. As a result, the second receptacle periphery 435 and the protruding base 430 may have a step therebetween. When the plug connector 10 is fastened to the receptacle connector 20, the step formed by the second receptacle periphery 435 and the protruding base 430 may correspond to the recess 100R of the first housing 100. For example, a sidewall of the protruding base 430 intersecting the second direction Y may be disposed beneath the first protruding wall 122 and the second protruding wall 124.

In some embodiments, a front end of the second receptacle periphery 435 may protrude beyond the front end of the first receptacle periphery 410. For example, a front surface of the second receptacle periphery 435 may be connected to a front surface of the protruding base 430. Although the front surface of the second receptacle periphery 435 is illustrated as being coplanar with the front surface of the protruding base 430, it should be understood that this structure is provided by way of example.

The receptacle locking portion 420 may protrude from the upper surface of the first receptacle periphery 410. When the plug connector 10 is fastened to the receptacle connector 20, the receptacle locking portion 420 may be fastened to the plug locking portion 140 of the first housing 100. For example, the receptacle locking portion 420 may be disposed between the first locking arm 142 and the second locking arm 144 and may be fastened to the locking arm bridge 146. In some embodiments, a front end of the receptacle locking portion 420 may be fastened to a rear surface of the locking arm bridge 146. With this structure, the second housing 400 may be fastened to the first housing 100 and the connector positioning unit 300 may support the first housing 100 fastened to the second housing 400.

When the plug connector 10 is fastened to the receptacle connector 20, the receptacle locking portion 420 may be guided by the locking guide 130 of the first housing 100. For example, the receptacle locking portion 420 may be inserted into the first guide groove 120H of the locking guide 130.

The receptacle mount 440 may extend from the second receptacle periphery 435. The receptacle mount 440 may be used to mount the second housing 400 on the circuit board 40. In some embodiments, the circuit board 40 may be disposed on a plane parallel to the first direction X (for example, on a plane intersecting the third direction Z). For example, the circuit board 40 may be disposed on a lower surface of the second housing 400. In some embodiments, the receptacle mount 440 may extend from a rear end of the second receptacle periphery 435 along a plane intersecting the third direction Z.

The second fastening holders 600 may be used to hold the second housing 400 on the circuit board 40. For example, the second fastening holders 600 may be secured on the circuit board 40 after passing through the receptacle mount 440 in the third direction Z. Although the second fastening holders 600 are illustrated as being disposed on opposite sidewalls of the second receptacle periphery 435, it should be understood that this structure is provided by way of example and the number and locations of second fastening holders 600 may be changed, as needed.

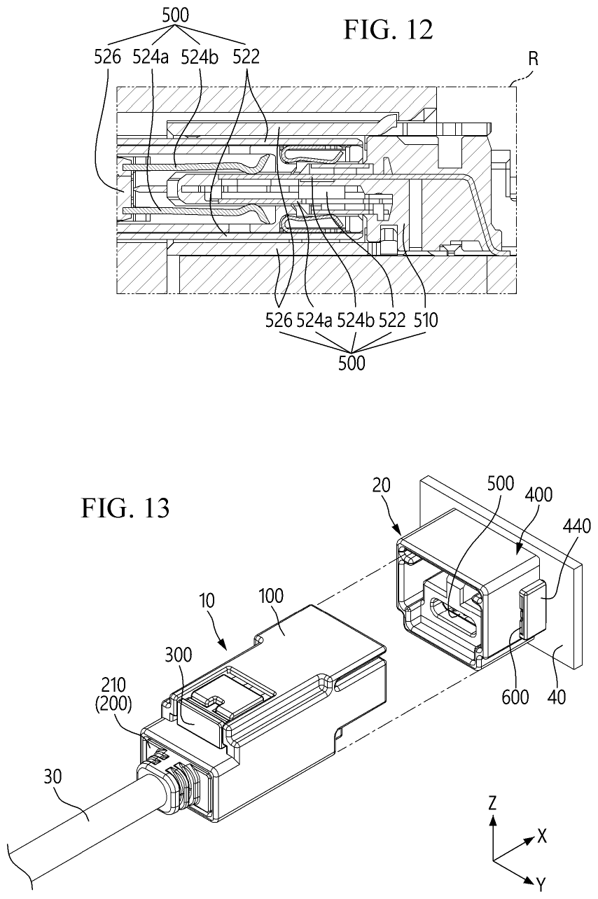

FIG. 13 is a perspective view of a connector assembly according to other embodiments of the present invention. For convenience of description, repeated description of components described with reference to FIG. 1 to FIG. 12 will be omitted.

Referring to FIG. 13, in the connector assembly according to the embodiments, a circuit board 40 on which the second housing 400 is mounted may be disposed on a plane intersecting the first direction X.

For example, the circuit board 40 may be disposed on a rear surface of the second housing 400. In some embodiments, receptacle mounts 440 may be formed on the opposite sidewalls of the second receptacle periphery 435. Further, a second fastening holder 600 may be secured on the circuit board 40 after passing through each of the receptacle mounts 440 in the first direction X.

Although some embodiments have been described herein, it should be understood that these embodiments are given by way of illustration only, and that various modifications, variations, and alterations can be made by those skilled in the art without departing from the spirit and scope of the present invention. Therefore, the scope of the invention should be limited only by the appended claims and equivalents thereto.

<List of Reference Numerals>

| | |
|---|---|
| 10: Plug connector | 20: Receptacle connector |
| 30: Cable | 40: Circuit board |
| 100: First housing | 100S1: First plug reception space |
| 100S2: Second plug reception space | 100R: Recess |
| 110: First plug periphery | 120: Second plug periphery |
| 120H: First guide groove | 130: Locking guide |
| 130S: Second guide groove | 140: Plug locking portion |
| 200: Plug terminal assembly | 210: Mold support |
| 220: First terminal structure | 300: Connector positioning unit |
| 350: First fastening holder | 400: Second housing |
| 400S1: First receptacle | 400S2: Second receptacle |
| reception space | reception space |
| 400F: Guide pin | 410: First receptacle periphery |
| 420: Receptacle locking portion | 430: Protruding base |
| 435: Second receptacle periphery | 440: Receptacle mount |
| 500: Second terminal structure | 600: Second fastening holder |

1. A connector assembly comprising:
a plug connector comprising a mold support, a first terminal structure protruding from the mold support in a first direction, and a first housing surrounding the mold support and the first terminal structure; and
a receptacle connector comprising a second terminal structure electrically connected to the first terminal structure and a second housing surrounding the second terminal structure and fastened to the first housing,
wherein the first housing comprises a cylindrical first plug periphery surrounding the mold support and extending in the first direction, and a second plug periphery protruding from the first plug periphery in the first direction and exposing a lower surface of the first terminal structure,
the second plug periphery comprising a protruding wall covering at least part of both sides of the first terminal structure and a cover covering an upper surface of the first terminal structure.

2. The connector assembly according to claim 1, wherein the second plug periphery protrudes beyond the first terminal structure in the first direction.

3. The connector assembly according to claim 1, wherein the first housing further comprises a recess disposed beneath the protruding wall and exposing a portion of a front surface of the first plug periphery.

4. The connector assembly according to claim 3, wherein:
the second housing comprises a first receptacle periphery surrounding the second terminal structure, a protruding base protruding from a lower portion of the first receptacle periphery and corresponding to the recess, and a second receptacle periphery surrounding the first receptacle periphery; and
the second plug periphery is inserted into a space between the first receptacle periphery and the second receptacle periphery.

5. The connector assembly according to claim 4, wherein the second receptacle periphery has a greater width than the protruding base in a second direction intersecting the protruding wall.

6. The connector assembly according to claim 4, wherein:
the protruding wall comprises a guide groove indented from an outer surface thereof and extending in the first direction; and
the second receptacle periphery comprises a guide pin protruding from an inner surface thereof and corresponding to the guide groove.

7. The connector assembly according to claim 4, wherein:
the first housing further comprises a plug locking portion disposed between the cover and the first terminal structure and extending in the first direction; and
the second housing further comprises a receptacle locking portion protruding from an upper surface of the first receptacle periphery and fastened to the plug locking portion.

8. The connector assembly according to claim 7, wherein:
the plug locking portion comprises a first locking arm and a second locking arm separated from each other and extending parallel to each other in the first direction, and a locking arm bridge extending in a second direction intersecting the first direction and connecting the first locking arm to the second locking arm; and
the receptacle locking portion is inserted into a space between the first locking arm and the second locking arm to be fastened to the locking arm bridge.

9. The connector assembly according to claim 7, wherein:
the first housing further comprises a locking guide disposed between the plug locking portion and the first terminal structure and protruding from an inner surface of the protruding wall;
the locking guide comprises a guide groove extending in the first direction; and
the receptacle locking portion is inserted into the guide groove.

10. The connector assembly according to claim 1, wherein the first terminal structure comprises a first mold structure held by the mold support, multiple plug terminals supported by the first mold structure, and a first cylindrical shell surrounding the multiple plug terminals and extending in the first direction, and the second plug periphery protrudes beyond the first shell in the first direction.

11. The connector assembly according to claim 1, wherein the second terminal structure comprises a second mold structure mounted on the circuit board, multiple receptacle terminals supported by the second mold structure, and a second cylindrical shell surrounding the multiple receptacle terminals and extending in the first direction.
